(19) United States
(12) Patent Application Publication
(10) Pub. No.: US 2024/0416400 A1
(43) Pub. Date: Dec. 19, 2024

(54) SYSTEM AND PROCESS FOR SEPARATION AND DIVERSION OF ORGANICS AND LIQUIDS FROM WASTE MATERIAL

(71) Applicant: Komar Industries, LLC, Groveport, OH (US)

(72) Inventors: Mark E. Koenig, Carroll, OH (US); Douglas C. Vanderlinden, Oakville (CA); Riel E. Johnson, Canyon Country, CA (US)

(21) Appl. No.: 18/742,878

(22) Filed: Jun. 13, 2024

Related U.S. Application Data
(60) Provisional application No. 63/507,903, filed on Jun. 13, 2023.
(60) Provisional application No. 63/634,114, filed on Apr. 15, 2024.

(51) Int. Cl. B09B 3/32

(52) U.S. Cl. CPC B09B 3/32

(57) ABSTRACT

A system and process to achieve significantly improved separation of organics or liquid from waste material. One example of a process for separating organics and liquids from waste material may comprise the steps of: compacting waste material such that organics or liquids are separated from the waste material; collecting the separated organics or liquids; and screening the waste material with a screen such that the waste material is adapted to be separated into undersized waste material and oversized waste material of the screen. A further example of the process may comprise the additional step of combining the separated organics or liquids with the undersized waste material of said screen to form a slurry. A related system is also included. Other variations of a process and system are also described that may include any of the aforementioned features and advantages.

This application claims the priority benefit of U.S. Provisional Application No. 63/507,903, filed Jun. 13, 2023, and U.S. Provisional Application No. 63/634,114, filed Apr. 15, 2024, which are each incorporated by reference in their entirety.

### BACKGROUND AND SUMMARY OF THE INVENTION

Exemplary embodiments of the present invention relate generally to the separation of organics and liquids from waste material.

A wide variety of materials may end up in the waste stream. Some of the material may be recyclable and/or convertible to another useful purpose (e.g., fuel, etc.). Organics and other types of liquids are often mixed with the garbage as well. For example, food, beverages, plants, and many other types of organics and other liquids become waste. These organics and other types of liquids may also be convertible to another useful purpose (e.g., fuel, fertilizer, compost, etc.).

However, in a waste stream, these potentially valuable materials are frequently intermixed. For example, municipal solid waste may originate from residential, commercial, institutional, and other industrial locations. Each waste load may be comprised of many different types of waste. Some waste loads may have a relatively high organics or other liquid content (such as waste from a restaurant or certain homes) in comparison to other loads. Moreover, after collection, a waste load may be further combined with even more variety of waste, such as upon delivery to a landfill or other transfer location, where waste streams may arrive from many different locations.

The mixing of various types of waste increases the difficulty or may even prevent the reuse of any particular type of waste. For example, waste saturated with organics and other types of liquids may not be suitable for recycling or conversion to another type of use. Likewise, organics and liquids interspersed with other waste may not be suitable for reuse, recycling, or conversion. For instance, some known separation systems may only separate less than about 20-45% (by weight or volume), and some even less than about 5% (by weight or volume), of the organics and liquids from the waste material. As a result, the remaining waste is difficult to process due to the excessive organics and liquids in the waste. For the same reason, it is more difficult to divert the waste to another useful purpose. Moreover, such diverted waste may also command limited value due to the presence of the organics and liquids. For example, in the current commercial market, such diverted waste may have no value, but rather a disposal cost.

In view of these concerns, there is a need for an improved and more efficient system and process for separating organics and liquids from waste. Along the same line, there are needs to improve the recovery and increase the recycling value of waste material. There is also a further need for an improved system and process that makes beneficial use of organics and liquids that have been separated from waste material.

An exemplary embodiment of the present invention may satisfy one or more of the aforementioned needs. For instance, an exemplary system may comprise a compaction system adapted to receive and compact waste material such that organics or liquids are separated from the waste material; a collection container adapted to receive the organics or liquids separated by said compaction system; a first screen adapted to receive the waste material from said compaction system, said first screen having screen openings of a first area such that the waste material is adapted to be separated into undersized waste material and oversized waste material of said first screen; and a second screen adapted receive the undersized waste material from said first screen, said second screen having screen openings of a second area smaller than said first area of said first screen such that the undersized waste material of said first screen is adapted to be separated into undersized waste material and oversized waste material of said second screen; wherein said system is adapted to combine the organics or liquids from the collection container with the undersized waste material of said second screen to form a slurry. Similarly, an exemplary process may comprise the following steps: compacting waste material such that organics or liquids are separated from the waste material; collecting the separated organics or liquids; screening the waste material with a first screen such that the waste material is adapted to be separated into undersized waste material and oversized waste material of said first screen; screening the undersized waste material of said first screen with a second screen such that the undersized waste material of said first screen is adapted to be separated into undersized waste material and oversized waste material of said second screen; and combining the separated organics or liquids with the undersized waste material of said second screen to form a slurry. In an exemplary system or process, significantly improved separation of organics or liquid from waste material may be achieved, wherein the slurry may also facilitate improved recovery of recyclable or reusable material.

Other exemplary embodiments of a system and process may also achieve significantly improved separation of organics or liquid from waste material. In this regard, another exemplary embodiment of a system may comprise a compaction system adapted to receive and compact waste material such that organics or liquids are separated from the waste material; a collection container adapted to receive the organics or liquids separated by said compaction system; and a screen adapted to receive the waste material from said compaction system, said screen having screen openings of an area such that the waste material is adapted to be separated into undersized waste material and oversized waste material of said screen; wherein said system is adapted to combine the organics or liquids from said collection container with the undersized waste material of said screen to form a slurry. Similarly, an exemplary process may comprise the following steps: compacting waste material such that organics or liquids are separated from the waste material; collecting the separated organics or liquids; screening the waste material such that the waste material is adapted to be separated into undersized waste material and oversized waste material of said screen; and combining the separated organics or liquids with the undersized waste material of said screen to form a slurry. In such an exemplary system or process, significantly improved separation of organics or liquid from waste material may again be achieved relative to the known art, wherein the slurry may also facilitate improved recovery of recyclable or reusable material.

More broadly, another variation of a system and process may achieve significantly improved separation of organics or liquid from waste material with at least one compaction system or process. For example, another exemplary embodiment of a system may comprise a compaction system adapted to receive and compact waste material such that organics or liquids are separated from the waste material; a screen adapted to receive the waste material from said compaction system, said screen having screen openings of an area such that the waste material is adapted to be separated into undersized waste material and oversized waste material of said screen; and a collection container adapted to receive the organics or liquids separated by said compaction system. In a further exemplary embodiment, at least one additional compaction system may also be included. In one such an example, a second compaction system is adapted to receive and compact the undersized waste material of said screen such that organics or liquids are separated from the waste material; wherein said collection container is also adapted to receive the organics or liquids separated by said second compaction system. Similarly, an exemplary process may comprise the following steps: compacting waste material such that organics or liquids are separated from the waste material; collecting the separated organics or liquids; and screening the waste material such that the waste material is adapted to be separated into undersized waste material and oversized waste material of said screen. In a further exemplary embodiment, at least one additional compaction step may also be included. For one example, a process may further include an additional step of compacting the undersized waste material of said screen such that additional organics or liquids are separated from the waste material, wherein the additional separated organics or liquids may also be collected. In such exemplary systems or processes, significantly improved separation of organics or liquid from waste material may again be achieved relative to the known art.

Other variations of a system and process may not require a screen to achieve significantly improved separation of organics or liquid from waste material. In one such example, a system may comprise a compaction system adapted to receive and compact waste material such that organics or liquids are separated from the waste material; a collection container adapted to receive the organics or liquids separated by the compaction system; and a homogenization system (e.g., a mixer) adapted to process (e.g., mix) the separated organics or liquids to form a slurry. Similarly, an exemplary process may comprise the following steps: compacting waste material such that organics or liquids are separated from the waste material; collecting the separated organics or liquids; and processing the separated organics or liquids to form a slurry. For example, some embodiments of a system or process may comprise a compaction or separation system or process that does not require the use of a screen or does not work well with a screen. Other examples of a system or process may not use a screen such as for cost, space, end use requirements, or other reasons. In any event, such exemplary systems or processes may achieve significantly improved separation of organics or liquid from waste material relative to the known art.

Any of the aforementioned embodiments may include additional components or systems, and/or additional process steps, to further facilitate the improved separation of organics or liquid from waste material, and/or the improved recovery of recyclable or reusable material.

Also, there may be a process that is related to any system of the present invention that is described herein. Likewise, there may be a system that is related to any process of the present invention that is described herein.

In addition to the novel features and advantages mentioned above, other benefits will be readily apparent from the following descriptions of the drawings and exemplary embodiments.

### BRIEF DESCRIPTION OF THE DRAWINGS

FIG. 1 is a flow diagram of an exemplary process of the present invention for separating and diverting organics or liquid from waste material.

FIG. 2 is a flow diagram of another exemplary process of the present invention for separating and diverting organics or liquid from waste material.

FIG. 3 is a flow diagram of another exemplary process of the present invention for separating and diverting organics or liquid from waste material, wherein exemplary objectives, descriptions, images, target applications, and value propositions are provided for the purpose of an example.

FIG. 4 is a schematic drawing of an exemplary system of the present invention for separating and diverting organics or liquid from waste material.

FIG. 5 is a schematic drawing of another exemplary system of the present invention for separating and diverting organics or liquid from waste material.

FIG. 6 is a flow diagram of another exemplary process of the present invention for separating and diverting organics or liquid from waste material.

FIG. 7 is a flow diagram of another exemplary process of the present invention for separating and diverting organics or liquid from waste material.

FIG. 8 is a flow diagram of another exemplary process of the present invention for separating and diverting organics or liquid from waste material.

### DETAILED DESCRIPTION OF EXEMPLARY EMBODIMENT(S)

Exemplary embodiments of the present invention are directed to a system and process for separating and diverting organics and liquids from waste material.

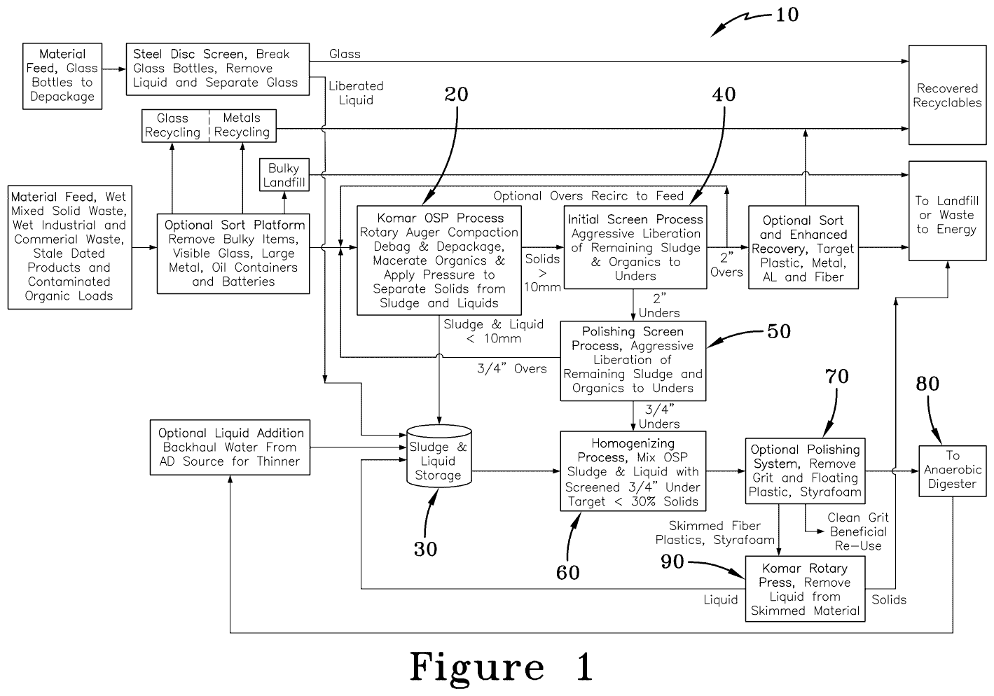

FIG. 1 shows an exemplary embodiment of a process 10 of the present invention for separating and diverting organics or liquids from waste material. In a first step 20, the waste material is compacted such that organics or liquids are separated from the waste material. In a common scenario, the waste material may be municipal waste. In other scenarios, the waste material may be from any source (e.g., directly from a factory, restaurant, business, etc.). In this example, an organics separation system and process comprising a rotary auger by Komar Industries, LLC (which are commercially available at www.komarindustries.com) may be used to compact the waste material such that organics or liquids are separated from the waste material. Additionally, U.S. Patent Publication No. 2020/0398321, filed Jun. 24, 2020, describes exemplary embodiments of a system and process for separating organics or liquids from waste material. Other exemplary embodiments may utilize another type of separation system and process (e.g., a ram or press to compact the waste material).

The separated organics or liquids are then collected as shown as shown at step 30. Meanwhile, in step 40, the waste material is screened with a first screen such that the waste material is separated into undersized waste material and oversized waste material of the first screen. More particularly, the first screen may have screen openings of a first area such that the waste material separated into undersized waste material and oversized waste material. Examples of a first screen may have a first area defined by about a two-inch to 4-inch diameter or sides. This example of a first screen process is adapted to produce two-inch unders. However, other exemplary embodiments may utilize a screen having another desired area to separate the waste material into undersized waste material and oversized waste material.

In step 50, the undersized waste material of the first screen is then screened with a second screen such that the undersized waste material of the first screen is adapted to be separated into undersized waste material and oversized waste material of the second screen. More particularly, the second screen may have screen openings of a second area smaller than the first area of the first screen such that the undersized waste material of the first screen is adapted to be separated into undersized waste material and oversized waste material of the second screen. For example, a second screen may have a second area defined by about a ½-inch to 1-inch diameter or sides. This example of a second screen process is adapted to produce ¾-inch unders. However, other exemplary embodiments may utilize a screen having another desired area to further separate the waste material into undersized waste material and oversized waste material.

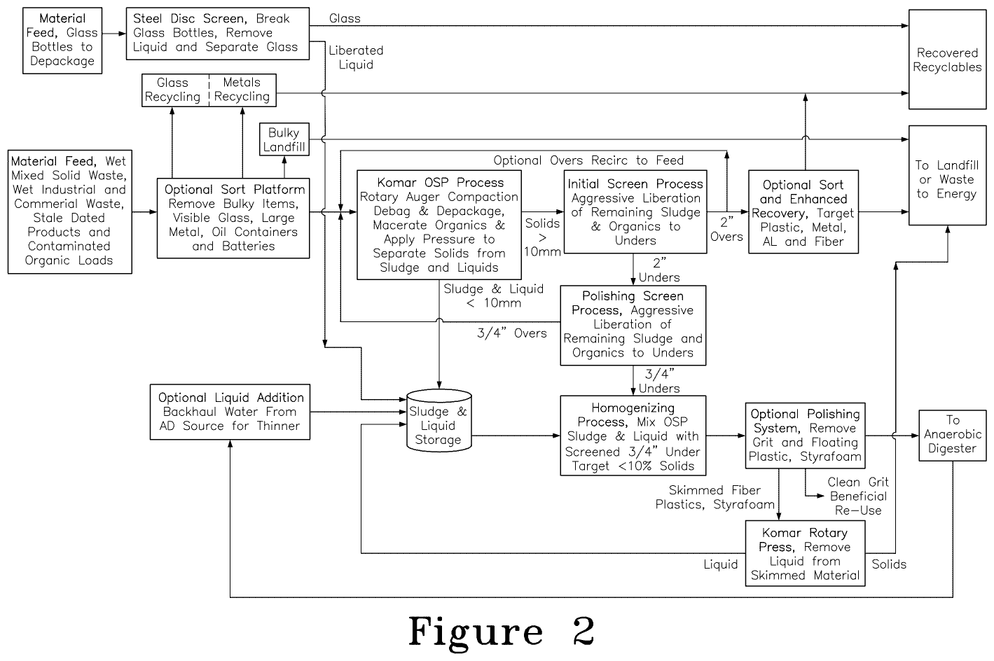

Thereafter, in step 60, the separated organics or liquids are combined with the undersized waste material of the second screen to form a slurry. An example of a slurry may comprise less than about 30% by weight of solid waste. Other embodiments may comprise another desired amount of solid waste. For example, FIG. 2 shows an example of a similar process with the exception that a slurry may comprise less than about 10% by weight of solid waste.

Optionally, a slurry may then proceed to a polishing step 70 (e.g., to remove grit, floating plastic, styrofoam, etc.), an anaerobic digestion step 80, and/or another separation step 90 (which may comprise a separation system commercially available from Komar Industries, LLC or another suitable separation system as previously described) in any order to separate the organics or liquids from the waste material, and also facilitate improved recovery of recyclable or reusable material. As a result, an exemplary embodiment may provide significantly enhanced or optimal recovery of organics and liquids and maximum fuel value for anaerobic digestion. For instance, one exemplary embodiment may separate more than about 70% (by weight or volume), more preferably at least about 80% (by weight or volume), and even more preferably at least about 90% (by weight or volume), of the organics and liquids from the waste material.

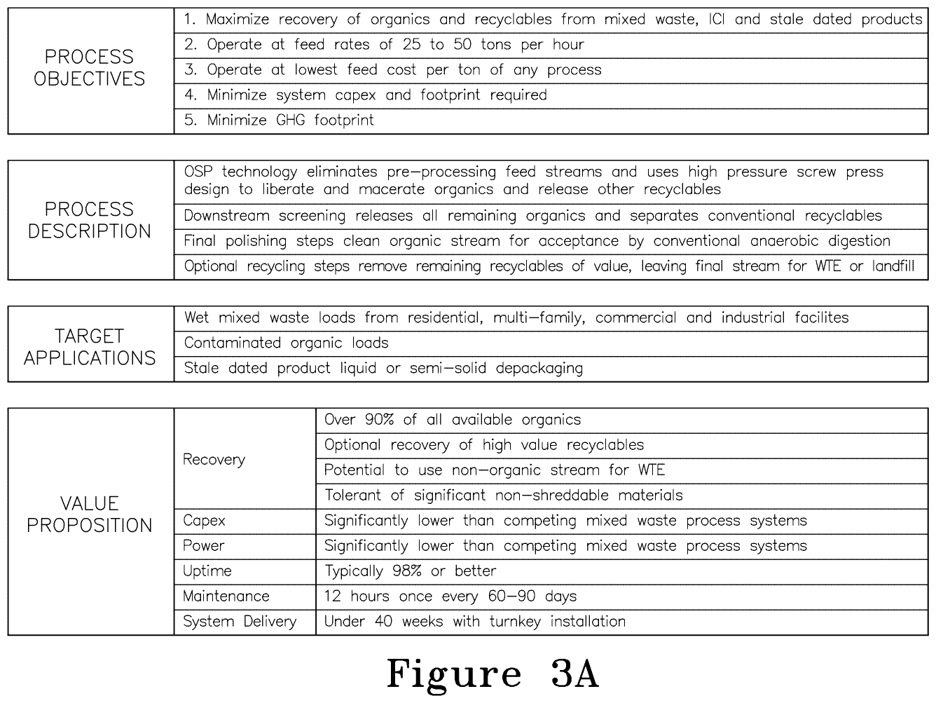

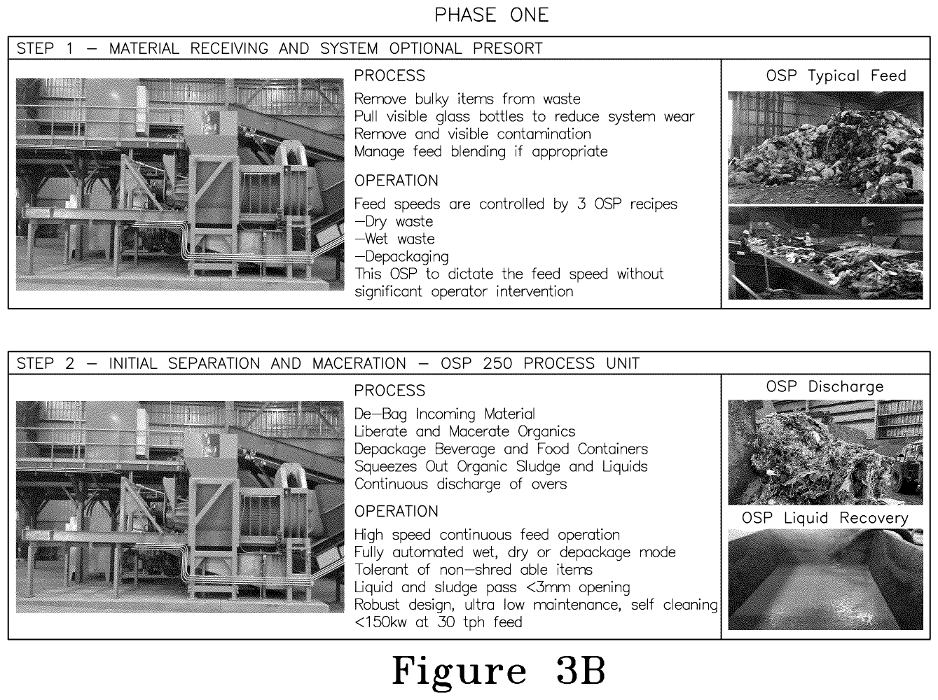

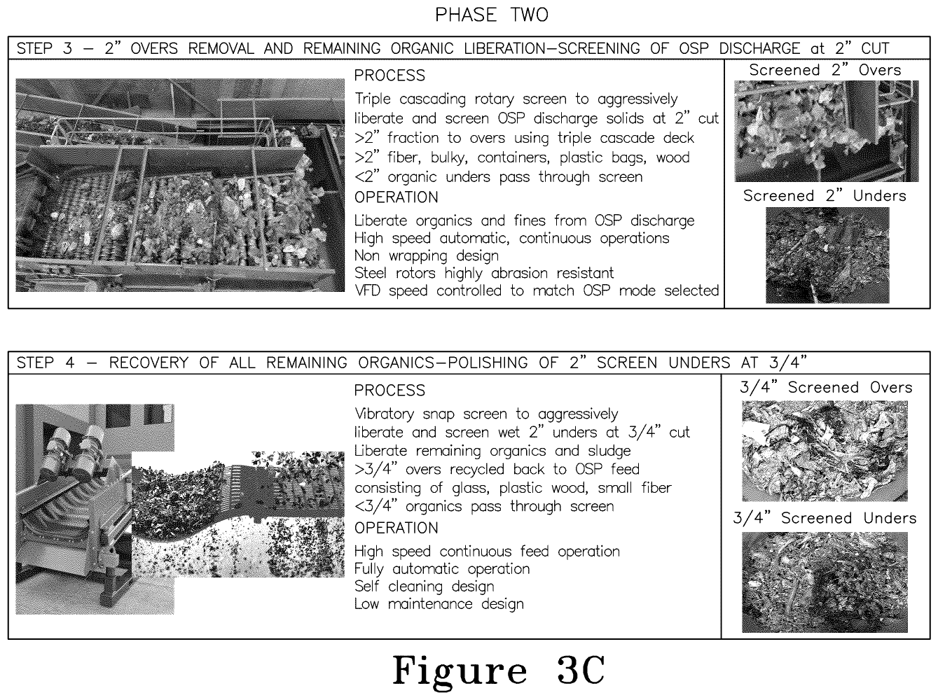

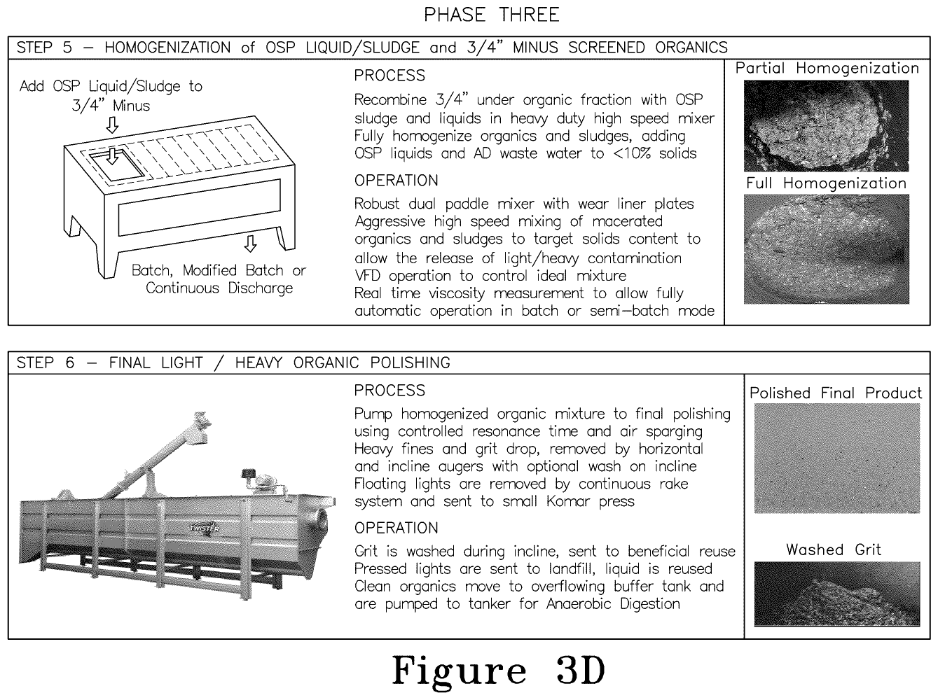

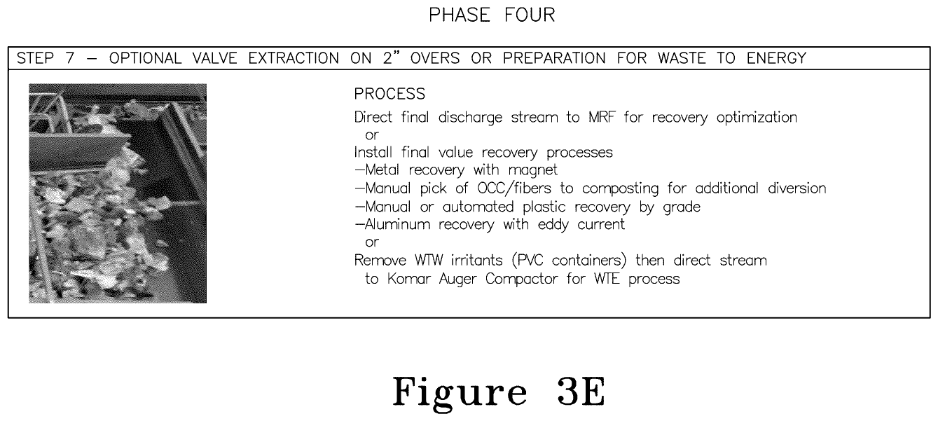

FIG. 3 describes another example of a process and related system that may be similar to the aforementioned processes and systems. FIG. 3 further describes objectives, descriptions, images, target applications, and value propositions for the purpose of one example. Other embodiments may comprise any of the features of FIG. 3, and vice versa.

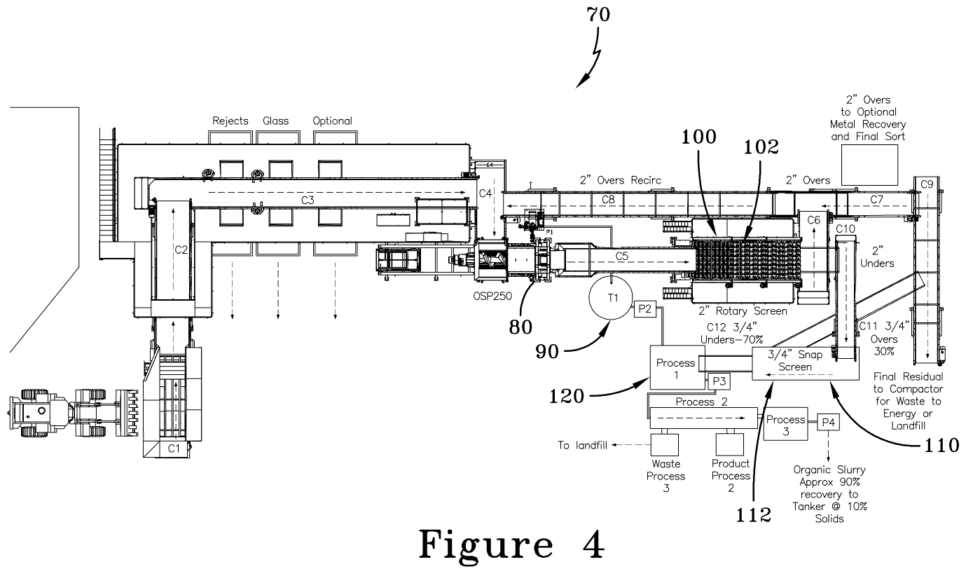

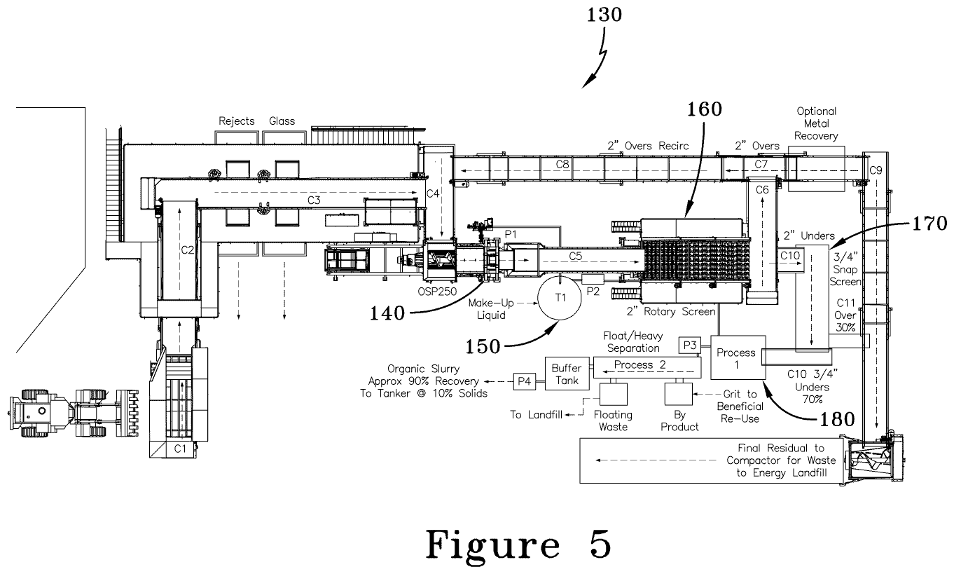

FIGS. 4 and 5 show examples of systems adapted to separate organics or liquids from waste material. These systems may be adapted to implement any of the aforementioned processes. These systems may also be adapted to implement additional optional stages to optimize the separation of organics or liquids from waste material, which in turn may optimize the recovery and diversion of the waste material.

In FIG. 4, system 70 comprises a compaction system 80 adapted to receive and compact waste material such that organics or liquids are separated from the waste material; a collection container 90 adapted to receive the organics or liquids separated by the compaction system 80; a first screen 100 adapted to receive the waste material from the compaction system, the first screen 100 having screen openings 102 of a first area such that the waste material is adapted to be separated into undersized waste material and oversized waste material of the first screen; and a second screen 110 adapted receive the undersized waste material from the first screen, the second screen 110 having screen openings 112 of a second area smaller than the first area of the first screen 100 such that the undersized waste material of the first screen 100 is adapted to be separated into undersized waste material and oversized waste material of the second screen; wherein the system 70 is adapted to combine the organics or liquids from the collection container 90 with the undersized waste material of the second screen 110 to form a slurry, which is shown at process 120. On the other hand, in FIG. 5, a system 130 may also comprise a compaction system 140; a collection container 150; a first screen 160; and a second screen 170; wherein the system 130 is adapted to combine the organics or liquids from the collection container 150 with the undersized waste material of the second screen 170 to form a slurry, which is shown at process 180. In these examples, process 120 and process 180 may, respectively, be a homogenization step or otherwise comprise a homogenizer. Nonetheless, exemplary embodiments may not necessarily achieve absolute homogenization. Such embodiments may include any of the features or advantages of the other embodiments of the invention, and vice versa. Also, such as previously described, these exemplary embodiments may, respectively, also comprise additional systems or steps to separate the organics or liquids from a slurry, and also facilitate improved recovery of recyclable or reusable material.

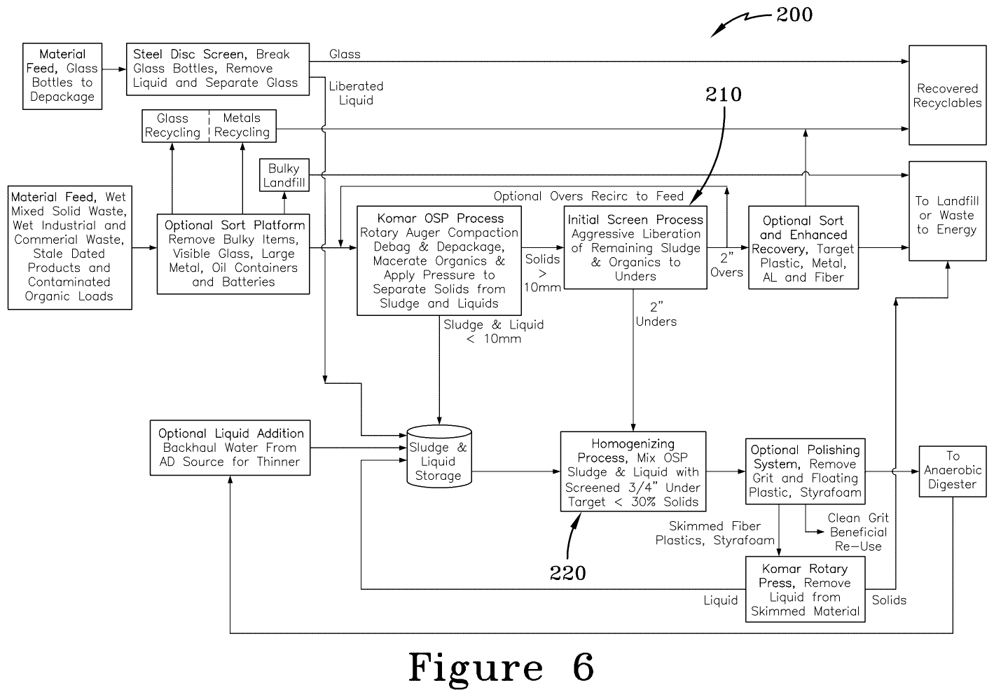

Other embodiments may benefit from any of the steps or features of the aforementioned examples. FIG. 6 shows an example of a process 200 that comprises only one screening process. In step 210, which may be similar to step 40 of FIG. 1, a screen separates the waste material into undersized waste material and oversized waste material. Thereafter, in step 220, the undersized waste material of the screen is combined with separated organics or liquids to form a slurry. Process 200 may otherwise be similar to process 10 of FIG. 1, wherein significantly improved separation of organics or liquid from waste material may again be achieved, and the slurry may also facilitate improved recovery of recyclable or reusable material.

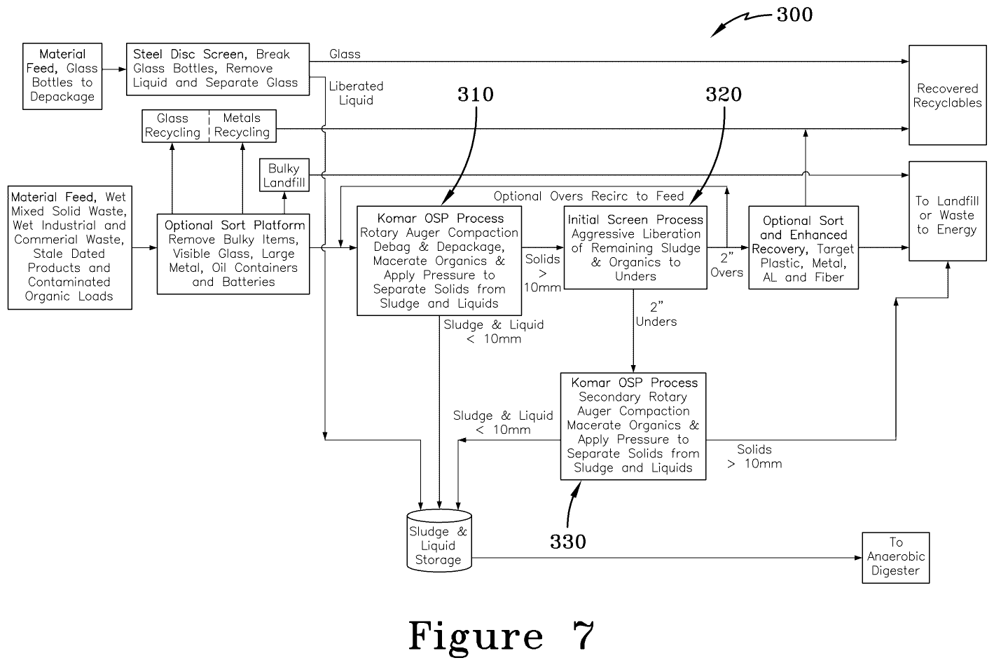

FIG. 7 shows an example of a process 300 that also comprises only one screening process. In a first step 310, which may be similar to first step 20 of FIG. 1, the waste material is compacted such that organics or liquids are separated from the waste material. Thereafter, a screen separates the waste material into undersized waste material and oversized waste material in step 320, which may be similar to step 40 of FIG. 1. Next, in step 330, the undersized waste material is compacted again such that further organics or liquids are separated from the waste material. However, some other exemplary embodiments may not include step 330. Such embodiments may otherwise be similar to process 300.

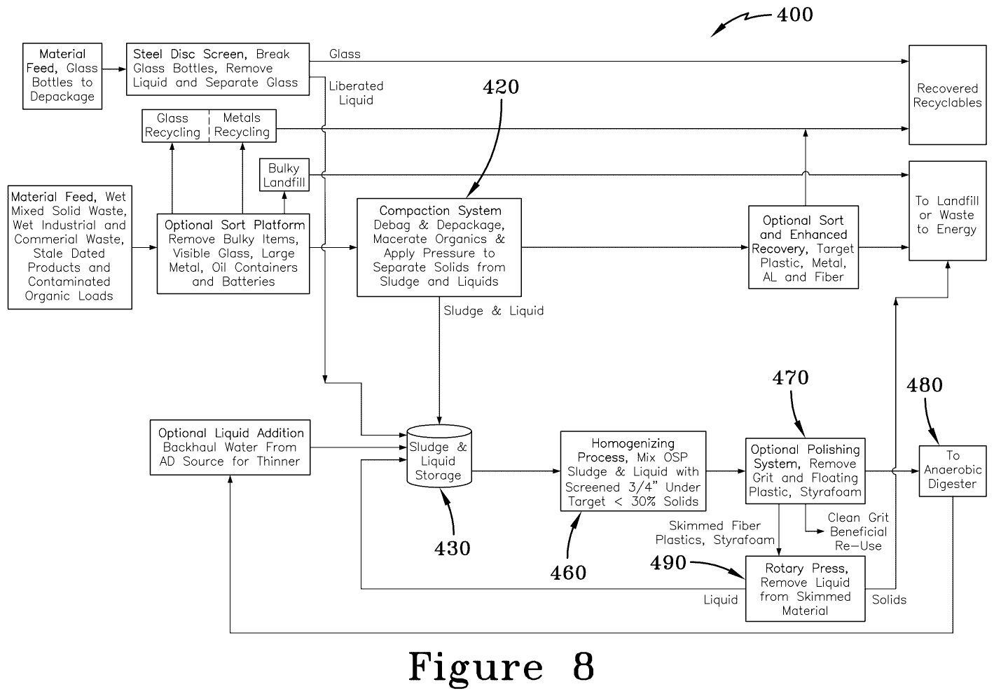

As addressed with respect to FIG. 1, any of the foregoing exemplary embodiments may utilize another type of compaction or separation system or process other than a rotary auger such as is available from Komar Industries. For example, a ram, press, or another suitable type of compaction or separation system or process may be used unless otherwise noted. FIG. 8 shows an example of another process 400 that may optionally comprise a different type of compaction or separation process as compared to the previous figures. For instance, process 400 may utilize a press, ram, rotary auger, or other suitable compaction or separation process. Process 400 may otherwise be similar to process 10 of FIG. 1 minus steps 40 and 50. In a first step 420, the waste material is compacted such that organics or liquids (e.g., sludge and liquid unders of a press) are separated from the waste material. The separated organics or liquids are then collected as shown at step 430. Thereafter, in step 460, the separated organics or liquids are homogenized to form a slurry. Optionally, the slurry may then proceed to a polishing step 470, an anaerobic digestion step 480, and/or another separation step 490. Other than the lack of a screened input or steps, steps 430, 460, 470, 480, and 490 may be similar to steps 30, 60, 70, 80, and 90 of FIG. 1.

Indeed, as mentioned or alluded to above and in the figures, any of the aforementioned embodiments may include additional separation or compaction processes to clean (i.e., prepare) a slurry for another purpose. For example, at least one mechanical separation process or system (e.g., a screen, cyclone, pulper, grit separator, etc.) may be used to clean a slurry, e.g., to meet the input specification of an anerobic digestor. Other embodiments may have at least one non-mechanical separation process to clean a slurry. As a further example, some embodiments may have at least one mechanical separation process or system and at least one non-mechanical separation process to clean a slurry.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention.

What is claimed is:

1. A system for separating organics and liquids from waste material, said system comprising:
a compaction system adapted to receive and compact waste material such that organics or liquids are separated from the waste material;
a collection container adapted to receive the organics or liquids separated by said compaction system;
a first screen adapted to receive the waste material from said compaction system, said first screen having screen openings of a first area such that the waste material is adapted to be separated into undersized waste material and oversized waste material of said first screen; and
a second screen adapted receive the undersized waste material from said first screen, said second screen having screen openings of a second area smaller than said first area of said first screen such that the undersized waste material of said first screen is adapted to be separated into undersized waste material and oversized waste material of said second screen;
wherein said system is adapted to combine the organics or liquids from said collection container with the undersized waste material of said second screen to form a slurry.

2. A process for separating organics and liquids from waste material, said process comprising the steps of:
compacting waste material such that organics or liquids are separated from the waste material;
collecting the separated organics or liquids;
screening the waste material with a first screen such that the waste material is adapted to be separated into undersized waste material and oversized waste material of said first screen;
screening the undersized waste material of said first screen with a second screen such that the undersized waste material of said first screen is adapted to be separated into undersized waste material and oversized waste material of said second screen; and
combining the separated organics or liquids with the undersized waste material of said second screen to form a slurry.

3. A process for separating organics and liquids from waste material, said process comprising the steps of:
compacting waste material such that organics or liquids are separated from the waste material;
collecting the separated organics or liquids; and
screening the waste material with a screen such that the waste material is adapted to be separated into undersized waste material and oversized waste material of said screen.

4. The process of claim 3 further comprising the step of combining the separated organics or liquids with the undersized waste material of said screen to form a slurry.

5. The process of claim 3 further comprising the steps of:
compacting the undersized waste material of said screen such that additional organics or liquids are separated from the waste material; and
collecting the additional separated organics or liquids.

6. A process for separating organics and liquids from waste material, said process comprising the steps of:
screening waste material such that the waste material is separated into undersized waste material and oversized waste material; and
combining organics or liquids with the undersized waste material to form a slurry.

7. The process of claim 6 further comprising the step of compacting waste material such that organics or liquids are separated from the waste material;
wherein the separated organics and liquids are combined with the undersized waste material to form the slurry.
